(19) United States
(12) Patent Application Publication
(10) Pub. No.: US 2008/0179867 A1
(43) Pub. Date: Jul. 31, 2008

(54) Airbag for a vehicle passenger restraint system

(75) Inventors: Andreas Riedel, Illertissen (DE); Jochen Schaupp, Aalen (DE); Ralf Gutmann, Ulm (DE); Oliver Glockler, Nersingen (DE)

Correspondence Address: FOLEY AND LARDNER LLP;SUITE 500, 3000 K STREET NW, WASHINGTON, DC, 20007, US

(73) Assignee: Takata-Petri AG

(21) Appl. No.: 12/007,988

(22) Filed: Jan. 17, 2008

Related U.S. Application Data
(63) Continuation of application No. PCT/DE2006/001182, filed on Jul. 4, 2006.

(30) Foreign Application Priority Data
Jul. 18, 2005 (DE) 10 2005 034 250.7

(51) Int. Cl. B60R 21/26

(52) U.S. Cl. 280/742

(57) ABSTRACT

An airbag for a vehicle passenger restraint system includes at least one airbag chamber that can be filled with gas and has at least one outflow device through which gas can escape from the airbag chamber. The outflow device includes a tubular extension defined on a wall of the at least one airbag chamber that provides an outflow opening of the at least one airbag chamber. The airbag includes at least a first airbag chamber and a second airbag chamber. The tubular extension is defined on the first airbag chamber and extends into the second airbag chamber. When the airbag is triggered, the second airbag chamber is filled with gas solely by the tubular extension. The tubular extension bends over in the second airbag chamber when no gas is flowing through it to constitute a valve and allow gas to flow only in the direction of the second airbag chamber.

### CROSS-REFERENCE TO RELATED PATENT APPLICATIONS

This application is a Continuation of US Application PCT/DE2006/001182, filed Jul. 4, 2006, which is incorporated herein by reference in its entirety. This International Application was not published in English but was published in German as WO 2007/009427.

### BACKGROUND

The invention generally relates to an airbag for a vehicle passenger restraint system.

A typical vehicle airbag includes at least one airbag chamber that can be filled with gas and that is provided with at least one outflow device through which gas can escape from the airbag chamber.

### SUMMARY

One embodiment of the invention relates to an airbag for a vehicle passenger restraint system. The airbag comprises at least one airbag chamber that can be filled with gas and that includes at least one outflow device through which gas can escape from the airbag chamber. The outflow device comprises a tubular extension defined on a wall of the at least one airbag chamber that provides an outflow opening of the at least one airbag chamber. The airbag comprises at least a first airbag chamber and a second airbag chamber. The tubular extension is defined on the first airbag chamber and extending into the second airbag chamber. When the airbag is triggered, the second airbag chamber is filled with gas from the first airbag chamber solely by the tubular extension projecting into the second airbag chamber. The tubular extension bends over in the second airbag chamber when no gas is flowing through the tubular extension to constitute a valve and allow gas to flow through the tubular extension only in the direction of the second airbag chamber.

### BRIEF DESCRIPTION OF THE DRAWINGS

The invention will be explained in more detail below on the basis of several exemplary embodiments and with reference to the drawings, in which:

FIG. 1A is a schematic top view of superimposed layers of an airbag with an outflow device that comprises an additional layer and is arranged over an outflow opening of the airbag, according to a first exemplary embodiment;

FIG. 1B is a perspective sectional view of the arrangement in FIG. 1A according to an exemplary embodiment;

FIG. 2A is a schematic top view of superimposed layers of an airbag with an outflow device that comprises an additional layer and is arranged over an outflow opening of the airbag, according to a second exemplary embodiment;

FIG. 2B is a perspective sectional view of the arrangement in FIG. 2A according to an exemplary embodiment;

FIG. 3 is a schematic top view of superimposed layers of an airbag with an outflow device that comprises an additional layer and is arranged over an outflow opening of the airbag, according to a third exemplary embodiment;

FIG. 4A is schematic diagram of an airbag having a first chamber and a second chamber, where the second chamber is filled with gas via an airbag snorkel of the first chamber according to an exemplary embodiment;

FIG. 4B illustrates the airbag in FIG. 4A, where the airbag snorkel is bent over on the attainment of a substantially equal internal pressure in the two airbag chambers according to an exemplary embodiment;

FIG. 5A illustrates an exemplary embodiment of an airbag having a cylindrical shrink hose valve projecting outwards;

FIG. 5B illustrates the airbag in FIG. 5A, including a partially permeable sleeve that is sealed airtight by the shrunken hose being arranged in the shrink hose valve;

FIG. 6A illustrates an exemplary embodiment of an airbag in a first folding state and having a catch strap arrangement, which closes or exposes an outflow opening of the airbag according to the state of deployment of the airbag; and

FIG. 6B illustrates shows the arrangement in FIG. 6A in a second folding state.

### DETAILED DESCRIPTION

According to one exemplary embodiment, the restraint system may include an airbag as disclosed in U.S. Pat. No. 5,603,526, which is herein incorporated by reference in its entirety. The airbag may include a main fabric layer with an outflow opening covered by an additional fabric layer stitched to the main fabric layer. At a predetermined pressure, the additional fabric layer may tear open along a tear seam so that gas can escape from the interior of the airbag.

According to another exemplary embodiment, the restraint system may include the airbag system disclosed in US 2003/0209895, which is herein incorporated by reference in its entirety. The airbag system includes an airbag with an outflow opening defined by a cylindrical fabric connection that deploys outwards when a predetermined internal pressure in the airbag is reached.

According to another exemplary embodiment, the restraint system may include the airbag disclosed in US 2004/0130135, which is herein incorporated by reference in its entirety. The airbag include a cylindrical fabric connection that is turned outside when a specific internal pressure is reached and provides an outflow opening for the airbag.

According to another exemplary embodiment, the restraint system may include the vehicle passenger safety system disclosed in U.S. Pat. No. 6,832,778, which is herein incorporated by reference in its entirety. The vehicle passenger safety system includes outflow openings to the surroundings that are covered or exposed as a function of the state of deployment of an airbag.

The present invention may allow gas to flow out from an airbag into the open air or from a first airbag chamber into a second airbag chamber and/or may allow an airbag to be capable of controlling the direction of flow of the gas.

According to one exemplary embodiment, an outflow device of an airbag chamber is defined by an outflow opening in a main layer of the wall of the airbag chamber. A substantially tear-proof additional layer covers the outflow opening on the outside of the main layer. An intermediate layer at least partially joins the additional layer at its periphery to the main layer. The intermediate layer may be composed of silicone or any other material that may facilitate the joining of the addition layer and main layer. The additional layer forms a membrane that covers the outflow opening of the main layer and with the outflow opening forms a valve.

The outflow opening may allow a pressure-controlled escape of gas from the airbag chamber. When a predetermined pressure is reached in the airbag chamber, the additional layer may detach itself from the main layer due either to the additional layer detaching itself at least partially from the intermediate layer and/or the intermediate layer detaching itself at least partially from the main layer. In both cases gas can escape from the airbag chamber.

The additional layer may be fully joined along its periphery to the main layer via the intermediate layer prior to filling of the airbag with gas. The additional layer may be blown off by the main layer when a specific pressure is reached and may detach itself completely from the main layer. The additional layer may not tear, however, as it may be substantially tear-proof.

Alternatively, the additional layer may be fully joined along its periphery to the main layer via the intermediate layer prior to filling of the airbag with gas so that the additional layer only partially detaches itself from the main layer when a predetermined pressure is reached. A pressure-dependent overflow may occur in the event of a partial detachment of the additional layer. In a reversal of the direction of flow, the additional layer may act as a non-return valve and prevent flow of the gas into the airbag chamber. The additional layer may be a cover that lifts when an internal pressure is reached in the airbag chamber and subsides under a counter-pressure closing the outflow opening.

The intermediate layer preferably includes at least one opening area in which the additional layer detaches itself from the main layer when a predetermined pressure is reached and at least one holding area in which the additional layer is firmly joined to the main layer on and after the predetermined pressure is reached. The at least one holding area may include an additional seam to join the additional layer, the intermediate layer, and the main layer together in the corresponding area of the intermediate layer.

The additional layer may be only partially joined at its periphery to the main layer so that an outflow of gas is possible in any state of deployment of the airbag. An overflow of gas can occur without blowing off the additional layer. In a reversal of the direction of flow, the additional layer may act as a non-return valve and reduce or prevent flow of the gas into the airbag chamber. The additional layer may be a cover that lifts when an internal pressure is reached in the airbag chamber and subsides under a counter-pressure to close the outflow opening. This exemplary embodiment may allow further airbag chambers to be filled from the airbag chamber in question without any gas return flow occurring.

To partially connect the additional layer to the main layer, the intermediate layer may form multiple joining areas in which the additional layer is joined to the main layer and leave vacant areas between the joining areas in which the additional layer is not joined to the main layer so that gas can flow through the vacant areas.

According to another exemplary embodiment, the outflow device of the airbag chamber comprises an elongated tubular extension defined in the wall of the airbag chamber and that provides an outflow opening of the airbag chamber. The tubular extension—hereinafter also referred to as a snorkel—may be dimensionally unstable, for example when no gas is flowing through the snorkel may bend over and collapse. The airbag preferably has a first airbag chamber and a second airbag chamber with the tubular extension being formed on the first airbag chamber and extending into the second airbag chamber. The first airbag chamber and the second airbag chamber may be arranged one on top of the other with the tubular extension extending vertically upwards into the second airbag chamber when gas flows through the extension and collapsing due to gravity in the absence of a gas through-flow.

Thus the snorkel may be a snorkel valve; the snorkel bends over and is closed on cessation of the gas overflow (e.g., after an equalization of pressure in the two airbag chambers). Similarly the snorkel is closed when an excess pressure is reached in the second airbag chamber, for example because a vehicle occupant has come into contact with the second airbag chamber. Therefore, the gas cannot flow into the first airbag chamber. The snorkel is preferably formed from the same or a similar material as the airbag.

According to another exemplary embodiment, the outflow device of the airbag chamber comprises an elongated tubular extension that is formed in the wall of the airbag chamber and provides an outflow opening of the airbag chamber. The tubular extension—hereinafter also referred to as a shrink hose—is composed of a material that may undergo a shrinking process when heated. Heating occurs as gas flows through the shrink house, for example in the event of the airbag being triggered. The shrink hose may include a shrink hose valve, the cross section of which diminishes under increased heating, so that with increased heating the quantity of gas flowing out of the airbag also diminishes. Therefore, the gas venting is temperature-dependent as the cross section of the outflow opening is adjusted based on the temperature of the gas and/or shrink hose.

The shrink hose may be composed of a different material from the airbag and is preferably more dimensionally stable than the snorkel.

Preferably, a sealing sleeve is arranged in the tubular extension and includes gaps along its longitudinal wall through which gas can pass. The tubular extension may conform to the sleeve as the shrinking process progresses and close the gaps.

According to another exemplary embodiment, the outflow device of the airbag chamber comprises an outflow opening that is formed in a main layer of the wall of the airbag chamber and a flat catch strap that is fixed inside the airbag chamber and has at least one local gap. The local gap in the catch strap is arranged in the catch strap and the catch strap is arranged in the airbag chamber so that the local gap is in front of the outflow opening in at least one folding state of the airbag chamber. An outflow of gas from an airbag or, preferably, a filling of another airbag chamber as a function of the state of deployment of the airbag chamber. The catch strap may open or close the outflow opening in a specific deployment position.

Preferably, the catch strap is fed through at least one loop, which is defined on the inside of the airbag chamber wall adjacent to the outflow opening. Feeding the catch strap through the at least one loop may allow the catch strap to be positioned with its local opening over the outflow opening according to the state of deployment. The catch strap can be displaced in the airbag chamber relative to the outflow opening.

The Figures each show an airbag for a vehicle passenger restraint system that includes an outflow device. The outflow device is shown according to various exemplary embodiments in the individual Figures and allows gas to escape from an airbag chamber either into the open surroundings or into another airbag chamber of the airbag. The vehicle passenger restraint system includes other typical elements of a vehicle passenger restraint system such as a gas generator, airbag sensors, and a control device. In addition, according to some exemplary embodiments, the restraint system may include elements not shown in the Figures such as a diffuser, a gas lance, and/or a housing.

The airbags described can be configured in any way, for example as a front airbag for a driver, as a front airbag for a front seat passenger, as a side airbag, as a knee airbag, as a head airbag, etc. The outflow devices may be used in any airbag system of a motor vehicle.

Unless directly stated, the following description of the drawings does not distinguish between situations in which the gas flows into the open (e.g., the outdoor surroundings) via the outflow device and situations in which the gas flows from a first airbag chamber into one or more other airbag chambers via the outflow device. The airbags and outflow devices can be used according to any exemplary embodiment. Reference is made to an airbag chamber and where the airbag comprises only one chamber, the airbag chamber is synonymous with the airbag.

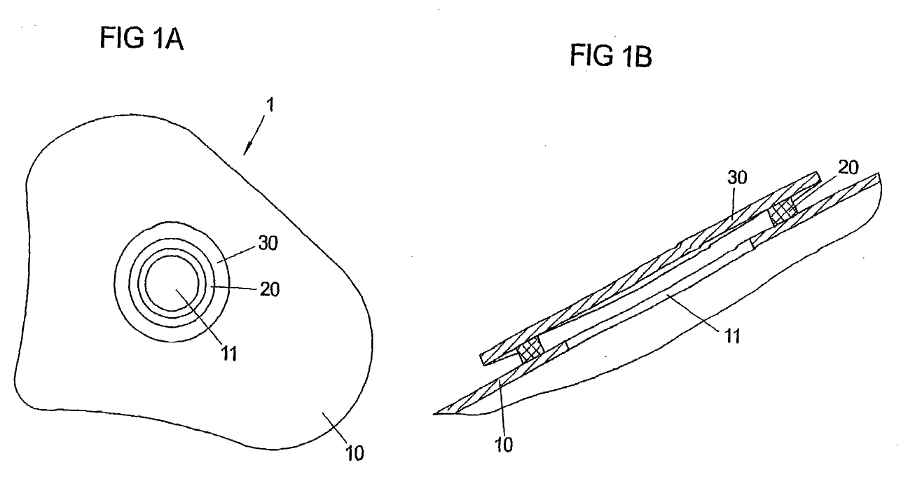

FIGS. 1A and 1B show an airbag chamber 1 with an airbag wall. The airbag wall comprises a fabric main layer 10. The main layer 10 includes one or more outflow openings 11 (vent holes). The outflow openings 11 may be circular, elliptical, triangular, rectangular, curvilinear, or any other shape. The main layer 10 may be composed of any material suitable for use in an airbag.

In the area of the opening 11 is an additional layer 30—hereinafter also referred to as a membrane—over the main layer 10. The additional layer 30 is preferably a fabric layer, however, any other laminar material, for example a plastic film or a metal foil, may be a material for the additional layer.

The membrane 30 is not joined to the main layer 10 by stitching but via an intermediate layer 20. The intermediate layer 20 joins the main layer 10 and the membrane 30. The intermediate layer 20 may be formed, for example, from silicone or a layer of adhesive.

According to FIGS. 1A and 1B, the membrane 30 is of generally circular shape with its edge protruding over the outflow opening 11 of the main layer 10. The outflow opening 11 and the membrane 30 may be of any other shapes that substantially correspond with one another so the membrane 30 can securely cover the outflow opening 11.

Along its periphery, the membrane 30 is joined to the main layer 10 via the intermediate layer 20 and closes the outflow opening 11. When a minimum pressure is reached in the airbag chamber 1, the membrane 30 is blown off. The membrane 30 may be tear-proof so that when the minimum pressure is reached the membrane 30 is detached as a whole from the main layer 10 without tearing.

According to various exemplary embodiments, the minimum pressure needed to blow the membrane 30 off varies, in particular, as a function of the thickness and width of the intermediate layer 20 and the relevant bonding or joining areas of the membrane 30 and the main layer 10 as well as the strength of the connection or adhesive bond.

The arrangement of FIGS. 1A and 1B produces a pressure-dependent opening of an outflow device comprising an outflow opening 11, an intermediate layer 20 and an additional layer 30.

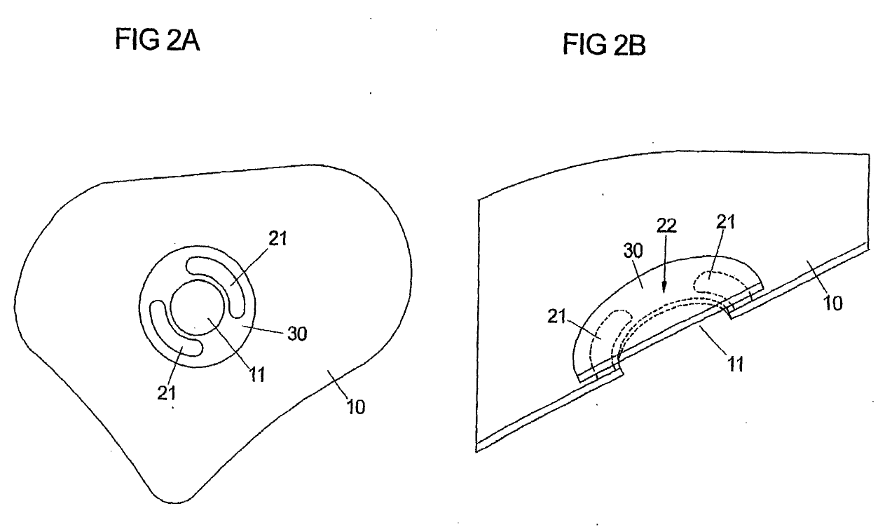

FIGS. 2A and 2B show an alternative exemplary embodiment that with an intermediate layer that differs from the layer in the exemplary embodiment of FIGS. 1A, 1B. Unlike the embodiment in FIGS. 1A, 1B, the intermediate layer in the embodiment in FIGS. 2A, 2B is not continuous but defines spatially joined areas 21 that are interrupted by vacant areas 22. The spatially joined areas 21 are shown as two arced areas 21 of the intermediate layer.

The partial peripheral joining of the membrane 30 to the main layer 10 allows air from the outflow opening 11 to flow through the outflow opening 11 and the vacant areas 22 in any state of deployment of the airbag chamber 1, for example into the surroundings or into a further airbag chamber. The membrane 30 laterally overlaps the outflow opening 11 and in the event of a reversal of the direction of flow the membrane may be a sealing element. A non-return valve may allow the flowing gas to pass through the outflow device or the valve formed thereby in one direction of flow. Gas flowing in the other direction of flow leads to closing of the valve. One or more other airbag chambers may be filled from a first airbag chamber with gas being unable to flow back into the first chamber from the other chambers.

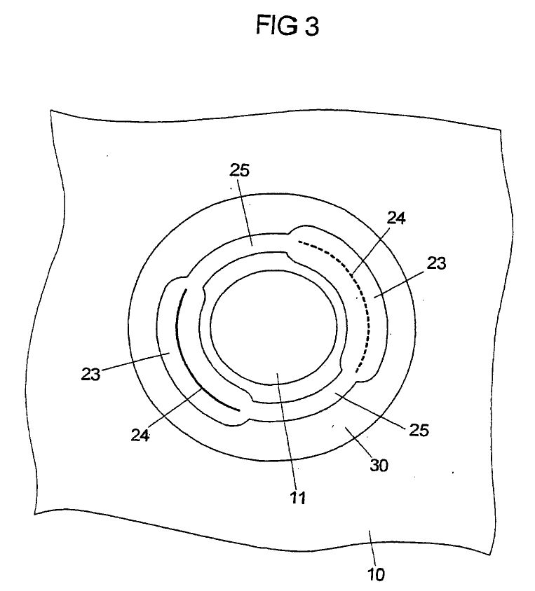

FIG. 3 shows a combination of the embodiments in FIGS. 1A, 1B and 2A, 2B according to another exemplary embodiment. As in FIG. 1A, 1B, the intermediate layer 20 is continuous and extends along the periphery of the membrane 30 between the intermediate layer 20 and the main layer 11. At least one area 23 includes an element 24 for preventing the membrane 30 from separating from the main layer 10 in the area 23. In the exemplary embodiment shown, the element 24 includes a seam that joins the membrane 30 and the main layer 10 together. In the illustrated embodiment two holding areas 23 are shown, although according to other exemplary embodiments more or fewer than two areas 23 may be included. The intermediate layer also forms opening areas 25 that are situated between the holding areas 23.

When a minimum pressure is reached in the airbag chamber 1, the opening areas 25 open while the membrane 30 along the holding areas 23 continues to be joined to the main layer 10. Therefore, an overflow of gas occurs into the surroundings or into another airbag chamber. A non-return valve closes the outflow opening 11 by the membrane 30 in the event of a reversal of the direction of gas flow. The non-return valve may only open in excess of a predetermined pressure.

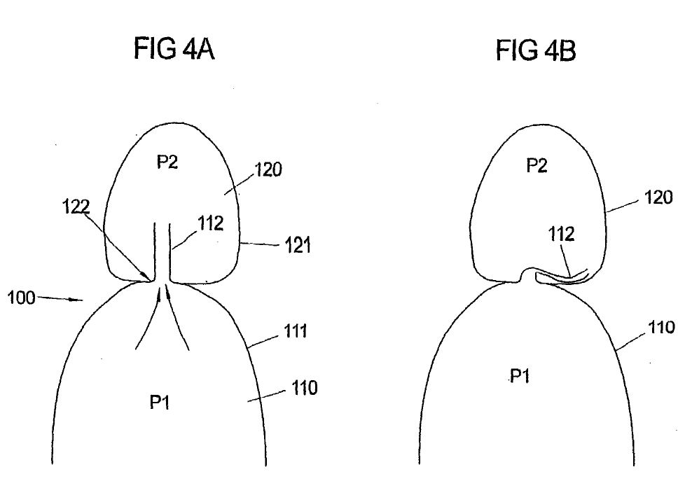

FIGS. 4A, 4B show an exemplary embodiment of an airbag 100 that includes at least two airbag chambers 110, 120, represented schematically. The airbag chambers 110, 120 may be two airbag chambers of a side airbag, for example, a chest chamber 110 and a head chamber 120.

The second chamber 120 is filled with gas by the first chamber 110. The airbag wall 111 of the first chamber 110 forms a cylindrical or tubular extension 112, hereinafter also referred to as a snorkel, which protrudes into a corresponding opening 122 in the wall 121 of the second airbag chamber 120. The snorkel 112 is composed of a generally dimensionally unstable material that collapses in the absence of an internal pressure. The snorkel 112 is preferably composed of the same material as the airbag wall 111.

FIG. 4A shows a situation in which a pressure P1 is reached in the first airbag chamber, which is greater than a pressure P2 in the second airbag chamber 120. Gas consequently flows through the snorkel 112 into the second airbag chamber 120. Due to the through-flow of gas and the associated internal pressure, the snorkel 112 is aligned generally straight and projects vertically upwards into the second airbag chamber 120.

FIG. 4B shows the situation in which the pressures P1, P2 in the two airbag chambers 110, 120 are substantially equal, for example the process of filling the second airbag chamber 120 is completed. The gas no longer flows through the snorkel 112, which collapses due to the lack of dimensional stability and the force of gravity, and bends over closing the snorkel 112. The bending of the snorkel 112 creates a snorkel valve that only allows gas to flow through in one direction.

The snorkel 112 likewise bends over if the pressure P2 in the second airbag chamber 120 is greater than the pressure P1 in the first airbag chamber 110, for example due to an impact by the occupant.

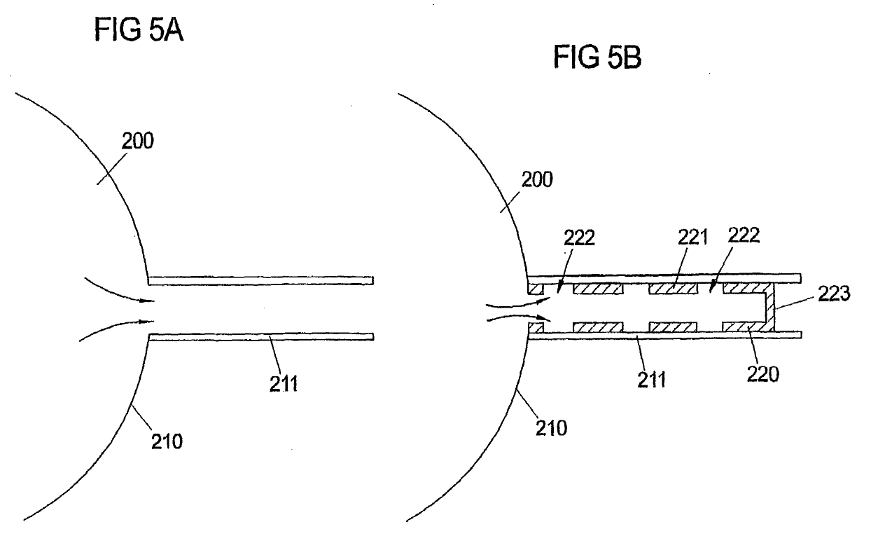

FIGS. 5A, 5B show an exemplary embodiment in which, according to FIG. 5A, an airbag chamber 200 in a wall 210 forms an outlet opening in the form of a hose 211. The hose 211 is of a generally cylindrical shape and is preferably dimensionally stable so that it does not collapse when no internal pressure exists. The hose 211 may be composed of a material that shrinks when heated so that when heating the cross section of the hose 211 and hence the quantity of gas flowing out of the airbag chamber 200 is reduced. The hose 211 is accordingly referred to hereinafter as a shrink hose 211.

One exemplary embodiment of using the shrink hose 211 for controlling the flow of a quantity of gas is shown in FIG. 5B. In the embodiment in FIG. 5B, a sleeve 220 has side wall areas 221 interrupted by openings 222 and is situated inside the shrink hose 211. An end 223 of the sleeve 220 that is remote from the airbag chamber 200 is closed. As long as the shrink hose 211 does not bear against the periphery of the sleeve 220, gas flowing out through the lateral openings 222 can flow outwards. Since the gas flowing out of a vehicle passenger restraint system is generally at a high temperature, the shrink hose 211 increasingly shrinks as the hot gas flows through and the shrink hose 211 comes to bear against the outside of the sleeve 220. When shrink hose 211 bears against the sleeve 220, gas can no longer pass outwards through the lateral openings 222 in the sleeve 220. The gas flow therefore diminishes more and more and may completely cease when the shrink hose 211 encounters the wall of the sleeve 220 due to the shrinkage.

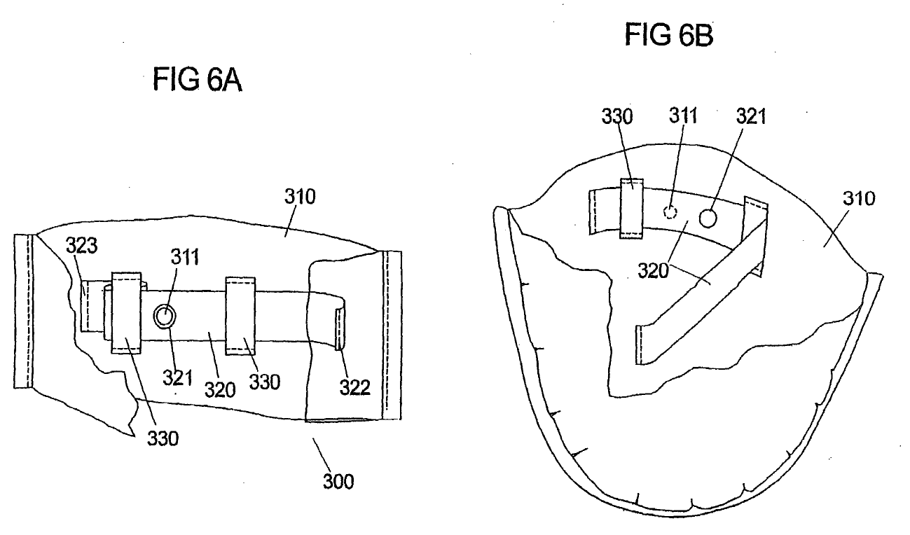

FIGS. 6A, 6B show an exemplary embodiment in which an outflow device of an airbag chamber is controlled by means of a catch strap. An airbag chamber 300 has an outflow opening 311 in an airbag wall 310. The outflow opening 311 allows gas to flow out into the surroundings of the airbag or into a further airbag chamber. A laminar catch strap 320, the two ends 322, 323 of which are fixed to the airbag wall 310, is situated over the outflow opening 311. Loops 330 are attached to or integrally formed with the airbag wall 310. The catch strap 320 is threaded through loops 330 adjacent to the outflow opening 320. In one of the loops 330 or elsewhere the catch strap 320 may be repeatedly folded so that a reserve of catch strap material exists.

In the non-deployed state in the illustrated embodiment, the opening 321 in the catch strap 320 is arranged over the outflow opening 311 in the airbag wall 310 so that when the airbag is deployed gas can flow out of the airbag chamber 300 through the openings 321, 311. During airbag deployment the catch strap 320 is tightened and the opening 321 in the catch strap 320 is displaced relative to the outflow opening 311 in the airbag wall 310 so that the openings no longer coincide. Once the opening 321 in the catch strap 320 no longer lies over the outflow opening 311, the catch strap 320 covers the outflow opening 311 and prevents any further outflow of gas.

The restraint system described in FIGS. 6A and 6B are to be taken only as an exemplary embodiment. In particular, it is also possible for the opening 321 in the catch strap 320 not to coincide with the outflow opening 311 in the non-deployed state of the airbag or the airbag chamber and for opening 321 and catch strap 320 to coincide only in a subsequent state of deployment or in the final state of deployment of the airbag so that an escape of gas via the outflow opening 311 is possible only at a later point in time. The exemplary embodiments depend on the desired control of the airbag internal pressure on deployment.

The developments described of an airbag for a vehicle passenger restraint system permit a reduction in the stresses acting on passengers in the case of release through outflow devices and allow for control of the quantity of gas escaping.

Germany Priority Application 10 2005 034 250.7, filed Jul. 18, 2005 including the specification, drawings, claims and abstract, is incorporated herein by reference in its entirety.

Given the disclosure of the invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag for a vehicle passenger restraint system comprises at least one airbag chamber that can be filled with gas and that includes at least one outflow device through which gas can escape from the airbag chamber, the outflow device comprises a tubular extension defined on a wall of the at least one airbag chamber that provides an outflow opening of the at least one airbag chamber,
wherein the airbag comprises at least a first airbag chamber and a second airbag chamber, the tubular extension being defined on the first airbag chamber and extending into the second airbag chamber,
wherein when the airbag is triggered, the second airbag chamber is filled with gas from the first airbag chamber solely by the tubular extension projecting into the second airbag chamber, and
wherein the tubular extension bends over in the second airbag chamber when no gas is flowing through the tubular extension to constitute a valve and allow gas to flow through the tubular extension only in the direction of the second airbag chamber.

2. The airbag as claimed in claim 1, wherein the first airbag chamber and the second airbag chamber are arranged one on top of the other and the tubular extension extends vertically upwards into the second airbag chamber when gas flows through the tubular extension.

3. The airbag as claimed in claim 1, wherein the first and second airbag chambers are two airbag chambers of a side airbag.

4. The airbag as claimed in claim 3, wherein the first and second airbag chambers define a chest chamber and a head chamber of a side airbag.

5. The airbag as claimed in claim 1, wherein the tubular extension is cylindrical.

6. The airbag as claimed in claim 1, wherein the tubular extension is composed of the same material as the wall.

7. The airbag as claimed in claim 1, wherein when the airbag is triggered the second airbag chamber is filled with gas from the first airbag chamber solely by the tubular extension projecting into the second airbag chamber and until the pressures in the first and second airbag chambers are substantially equal or until the pressure in the second airbag chamber is greater than the pressure in the first airbag chamber and the tubular extension in the second airbag chamber bends over.

8. An airbag for a vehicle passenger restraint system comprising:
a first airbag chamber that can be filled with gas;
a tubular extension for providing a path for gas to escape from the first airbag chamber, wherein the tubular extension is located on a wall of the first chamber and extends into a second airbag chamber,
wherein when the airbag inflates with gas, the second airbag chamber is filled with gas solely from the first airbag chamber through the tubular extension, and
wherein, when there is no gas flow through the tubular extension, the tubular extension is bent in the second airbag chamber and functions as a valve to allow gas to flow through the tubular extension only in the direction of the second airbag chamber.

9. The airbag as claimed in claim 8, wherein when the airbag is configured so that when the airbag inflates, the second airbag chamber fills with gas passing through the tubular extension until the pressure in the second airbag chamber is greater than or substantially equal to the pressure in the first airbag chamber and then the tubular extension in the second airbag chamber bends to prevent gas from flowing from the second airbag chamber to the first airbag chamber.
